(19) United States
(12) Patent Application Publication
(10) Pub. No.: US 2015/0014124 A1
(43) Pub. Date: Jan. 15, 2015

(54) GLASS SUBSTRATE CONVEYANCE DEVICE AND CONVEYANCE METHOD

(71) Applicant: Nippon Electric Glass Co., Ltd., Shiga (JP)

(72) Inventors: Hiroyuki Tagawa, Shiga (JP); Masao Tsukada, Shiga (JP); Akihisa Saeki, Shiga (JP); Taiki Minari, Shiga (JP)

(73) Assignee: Nippon Electric Glass Co., Ltd., Shiga (JP)

(21) Appl. No.: 14/376,698

(22) PCT Filed: Jan. 11, 2013
(86) PCT No.: PCT/JP2013/050411

§ 371 Date: Aug. 5, 2014

(30) Foreign Application Priority Data
Mar. 8, 2012 (JP) 2012-051769

(51) Int. Cl. B65G 17/32

(52) U.S. Cl. CPC B65G 17/323
USPC 198/468.2

(57) ABSTRACT

Provided is a glass substrate conveyance device (1), including a plurality of gripping means (10, 11) for gripping an upper edge portion (U) of a glass substrate (G) in a vertical posture so as to support the glass substrate (G) in a suspended manner, the glass substrate conveyance device (1) being configured to convey, in a conveyance direction (T) along the upper edge portion (U), the glass substrate (G) that is supported in the suspended manner by the plurality of gripping means (10, 11), in which the plurality of gripping means (10, 11) include at least one movable gripping means (10) that is changeable in position and/or posture in a horizontal plane.

### TECHNICAL FIELD

The present invention relates to a glass substrate conveyance device and a glass substrate conveyance method, and more particularly, to a technology for conveying a substrate in a vertical posture and then performing inspection and processes thereon.

### BACKGROUND ART

As is well known, as one type of devices for performing inspection and processes on glass substrates, there has been widely used a device for conveying a substrate in a vertical posture while supporting the substrate in a suspended manner under a state in which an upper edge thereof is gripped, and then performing inspection and processes on the substrate. An example of such a device is disclosed in Patent Literature 1.

The device disclosed in Patent Literature 1 includes upper gripping means for gripping an upper edge portion of a glass substrate conveyed from an upstream side, lower gripping means for gripping a lower edge portion of the substrate that is supported in a suspended manner by the upper gripping means, and defect inspection means for performing defect inspection, which is provided along a conveyance path for the substrate. In the configuration of the device disclosed in Patent Literature 1, the defect inspection is performed by causing the substrate gripped by both the upper and lower gripping means to pass through the defect inspection means during conveyance to the downstream side.

### CITATION LIST

Patent Literature 1: JP 2009-236711 A

### SUMMARY OF INVENTION

### Technical Problems

By the way, thin glass substrates for flat panel displays that have been mass-produced in recent years, such as a liquid crystal display and a plasma display, have been further thinned in accordance with an increase in demand for light-weighting of main body devices. Under such circumstances, there have arisen problems as described below at the time of performing the inspection and the processes on the substrate with the device as disclosed in Patent Literature 1.

Specifically, at the time of performing the inspection and the processes on the glass substrate, for example, a camera for imaging the substrate needs to be focused on the substrate, and a cutter for cutting the substrate needs to be pressed against the substrate. Thus, both an upper edge portion and a lower edge portion of the substrate need to be gripped so that the substrate is tensioned.

However, rigidities of the glass substrates that have been further thinned decrease in accordance with the thinning of the substrates, and hence even a slight difference in internal stress generated in the substrate causes deflection. Thus, the lower edge portion of the substrate that is supported in a suspended manner may be curved into an arch shape due to the deflection. As a result, there is a problem in that, for the inspection on the substrate, at the time of gripping the lower edge portion of the substrate that is conveyed with only the upper edge portion thereof being gripped as disclosed in Patent Literature 1, the lower edge portion of the substrate is difficult to smoothly grip with gripping means, or even impossible to grip.

When such problems occur, at the time of setting the lower edge portion of the substrate to the gripping means, the curved lower edge portion and the gripping means may collide against each other to crack or break the substrate. As a result, there occurs not only a disadvantage in that the yield of products is decreased, but also a disadvantage in that the fragments of the broken substrate remain on the gripping means.

Thus, in order to prevent the problems as described above, there is a need to implement design for facilitating the gripping of the lower edge portion of the substrate at the time of performing the inspection and the processes on the glass substrate. However, effective measures therefor have not yet been taken.

It is a technical object of the present invention that has been made in view of the circumstances described above to improve, for example, a yield of products by facilitating gripping of a lower edge portion of a glass substrate in a vertical posture at the time of performing inspection and processes after conveying the substrate that is supported in a suspended manner.

### Solution to Problems

According to one embodiment of the present invention devised to solve the problems described above, there is provided a glass substrate conveyance device, comprising a plurality of gripping means for gripping an upper edge portion of a glass substrate in a vertical posture so as to support the glass substrate in a suspended manner, the glass substrate conveyance device being configured to convey, in a conveyance direction along the upper edge portion, the glass substrate that is supported in the suspended manner by the plurality of gripping means, wherein the plurality of gripping means comprise at least one movable gripping means that is changeable in position and/or posture in a horizontal plane.

According to such a configuration, in the case where the glass substrate is conveyed while being supported in the suspended manner by the plurality of gripping means comprising the at least one movable gripping means, when the glass substrate is a thin flexible glass substrate, a lower edge portion of the glass substrate is deformed into a significantly curved shape in plan view. In a case where the lower edge portion of the glass substrate needs to be gripped for performing inspection and processes on the glass substrate after the glass substrate is conveyed under such a state, a preferred embodiment as described below can be carried out. Specifically, when the at least one movable gripping means is changed in position and/or posture in the horizontal plane under a state in which the upper edge portion of the glass substrate is gripped by the plurality of gripping means, the upper edge portion of the glass substrate is deformed from a linear shape into a non-linear shape (curved shape). Simultaneously, the lower edge portion of the glass substrate is also deformed along with the deformation of the upper edge portion. Thus, when a direction and a degree of the deformation are appropriately adjusted at the time of deforming the upper edge portion of the glass substrate into the non-linear shape with the at least one movable gripping means, the lower edge portion of the glass substrate can be deformed from the significantly curved shape into a shape that is close to the linear shape. With this, at the time of performing the inspection and the processes on the glass substrate, the lower edge portion deformed into the shape that is close to the linear shape can be easily and smoothly gripped by another gripping means provided on a lower side. As a result, cracking and breakage of the glass substrate can be prevented from being caused, for example, by interference of the another gripping means with the lower edge portion of the glass substrate. In this way, improvement of a yield of products and the like can be achieved.

In the configuration described above, it is preferred that the at least one movable gripping means be configured to pivot along a circular trajectory in the horizontal plane.

With this, along with the pivoting of the at least one movable gripping means, the upper edge portion of the glass substrate is deformed into the non-linear shape (curved shape). In accordance therewith, the lower edge portion of the glass substrate can be corrected into the shape that is close to the linear shape. In this case, the “pivoting of the at least one movable gripping means” means that the at least one movable gripping means is changeable in position and posture. Note that, in this case, a disadvantage in that high local stress may be generated due to the curving in the vicinity of a part of the glass substrate, which is gripped by the at least one movable gripping means, can be avoided.

In the configuration described above, it is preferred that the at least one movable gripping means be configured to turn on its axis about a vertical line.

With this, along with the turning of the at least one movable gripping means on its axis, the upper edge portion of the glass substrate is deformed into the non-linear shape (curved shape). In accordance therewith, the lower edge portion of the glass substrate can be corrected into the shape that is close to the linear shape. In this case, the “turning of the at least one movable gripping means on its axis” means that the at least one movable gripping means is changeable in posture. In this context, when the at least one movable gripping means not only pivots as described above but also turns on its axis, the lower edge portion of the glass substrate can be more effectively corrected into the shape that is close to the linear shape.

In the configuration described above, it is preferred that the at least one movable gripping means be configured to move in a direction that is perpendicular to the conveyance direction.

With this, along with the movement of the at least one movable gripping means in the direction that is perpendicular to the conveyance direction, the upper edge portion of the glass substrate is deformed into the non-linear shape (curved shape). In accordance therewith, the lower edge portion of the glass substrate can be corrected into the shape that is close to the linear shape. In this case, the “movement of the at least one movable gripping means in the direction that is perpendicular to the conveyance direction” means that the at least one movable gripping means is changeable in position. In this context, when the at least one movable gripping means not only pivots as described above but also moves in the direction that is perpendicular to the conveyance direction, or when the at least one movable gripping means not only turns on its axis but also moves in the direction that is perpendicular to the conveyance direction, the lower edge portion of the glass substrate can be more effectively corrected into the shape that is close to the linear shape.

In the configuration described above, it is preferred that the at least one movable gripping means be configured to move in a direction that is parallel to the conveyance direction.

With this, along with the movement of the at least one movable gripping means in the direction that is parallel to the conveyance direction, the upper edge portion of the glass substrate is deformed into the non-linear shape (curved shape). In accordance therewith, the lower edge portion of the glass substrate can be corrected into the shape that is close to the linear shape. In this case, the “movement of the at least one movable gripping means in the direction that is parallel to the conveyance direction” means that the at least one movable gripping means is changeable in position. In this context, when the at least one movable gripping means not only pivots as described above but also moves in the direction that is parallel to the conveyance direction, when the at least one movable gripping means not only turns on its axis but also moves in the direction that is parallel to the conveyance direction, or when the at least one movable gripping means not only moves in the direction that is perpendicular to the conveyance direction but also moves in the direction that is parallel to the conveyance direction, the lower edge portion of the glass substrate can be more effectively corrected into the shape that is close to the linear shape.

In the configuration described above, it is preferred that, during a period in which the glass substrate that is supported in the suspended manner by the plurality of gripping means is subjected to a predetermined process in a work area, the at least one movable gripping means be maintained in an initial state in which the at least one movable gripping means is unchanged in position and/or posture, and a lower edge portion of the glass substrate be gripped by a plurality of other gripping means.

With this, during the period in which the glass substrate is subjected to the predetermined process, the upper edge portion and the lower edge portion of the glass substrate can each be formed into the linear shape. Thus, the curve of the entire glass substrate can be removed, and a flat plate shape that is suited to the predetermined process is maintained. As a result, the predetermined process on the glass substrate can be smoothly and accurately performed.

In the configuration described above, it is preferred that the plurality of gripping means comprising the at least one movable gripping means be provided in a plurality of areas corresponding to a plurality of steps, and that, when the glass substrate that is supported in the suspended manner by the plurality of gripping means in a preceding step is transferred to the plurality of gripping means in a subsequent step, the at least one movable gripping means be maintained in the initial state in which the at least one movable gripping means is unchanged in position and/or posture.

With this, at the time of transferring the glass substrate to the subsequent step, the upper edge portion of the glass substrate can be restored into the linear shape. As a result, the glass substrate can be transferred smoothly from step to step.

In the configuration described above, it is preferred that the glass substrate conveyance device further comprise: drive means for driving the at least one movable gripping means; measurement means for measuring a deflection of the lower edge portion of the glass substrate; and control means for controlling the drive means in response to a signal from the measurement means.

With this, even in a case where a magnitude of the deflection of the glass substrate is frequently changed in accordance with changes, for example, in manufacturing condition of the glass substrate, when the control means is provided to control the drive means in response to the signal from the measurement means, the deformation of the upper edge portion can be adjusted in accordance with magnitudes of deflections of glass substrates.

In the configuration described above, it is preferred that the plurality of gripping means comprising the at least one movable gripping means be provided in the plurality of areas corresponding to the plurality of steps, and that, when the glass substrate that is supported in the suspended manner by the plurality of gripping means in the preceding step is transferred to the plurality of gripping means in the subsequent step, operation information of the drive means for driving the at least one movable gripping means in the preceding step be stored in advance, and the drive means for driving the at least one movable gripping means in the subsequent step be controlled based on the operation information that is stored in advance.

With this, for example, in a case where the lower edge portion of the glass substrate needs to be gripped again for performing an additional process in the subsequent step after the predetermined process is performed on the glass substrate, a preferred embodiment as described below can be carried out. Specifically, when the drive means in the subsequent step is caused to perform the same operation as that of the drive means in the preceding step based on the operation information of the drive means in the preceding step, which is stored in advance, the at least one movable gripping means performs, as a matter of course, the same operation as that of the at least one movable gripping means in the preceding step. With this, in the subsequent step, the lower edge portion of the glass substrate can be corrected into the shape that is close to the linear shape without any control on the at least one movable gripping means. Thus, work flow from step to step can be markedly smoothened.

In the configuration described above, a part of the plurality of gripping means may be replaced with a guide member for loosely holding and guiding the upper edge portion of the glass substrate.

With this, a part of the glass substrate, which is loosely held by the guide member, is not completely fastened. Thus, at the time when the at least one movable gripping means is changed in position and/or posture, a risk of generation of high local stress at that part can be reduced.

Further, according to one embodiment of the present invention devised to solve the problems described above, there is provided a glass substrate conveyance method, comprising a plurality of gripping means for gripping an upper edge portion of a glass substrate in a vertical posture so as to support the glass substrate in a suspended manner, the glass substrate conveyance method comprising conveying, in a conveyance direction along the upper edge portion, the glass substrate that is supported in the suspended manner by the plurality of gripping means, the plurality of gripping means comprising at least one movable gripping means that is changeable in position and/or posture in a horizontal plane, the conveying comprising conveying the glass substrate that is supported in the suspended manner by the at least one movable gripping means.

According to such a method, the same functions and advantages as those of the above-mentioned matters of the glass substrate conveyance device can be obtained.

### Advantageous Effects of Invention

As described above, according to one embodiment of the present invention, at the time of performing inspection and processes on the glass substrate in the vertical posture that has been conveyed while being supported in the suspended manner, the lower edge portion of the glass substrate can be more easily gripped. Thus, the problem of the decrease in yield of products due to failure in gripping can be solved.

### BRIEF DESCRIPTION OF DRAWINGS

FIG. 1 is a perspective view of a glass substrate conveyance device according to a first embodiment of the present invention.

FIG. 2 is a side view of a conveyance path for conveying a glass substrate.

FIG. 3a is a plan view of deformation between an upper edge portion and a lower edge portion of the glass substrate.

FIG. 3b is a plan view of deformation between the upper edge portion and the lower edge portion of the glass substrate.

FIG. 4 is a perspective view of a glass substrate conveyance device according to a second embodiment of the present invention.

FIG. 5a is a plan view of deformation between an upper edge portion and a lower edge portion of a glass substrate.

FIG. 5b is a plan view of deformation between the upper edge portion and the lower edge portion of the glass substrate.

FIG. 6 is a perspective view of a glass substrate conveyance device according to a third embodiment of the present invention.

FIG. 7a is a plan view of deformation between an upper edge portion and a lower edge portion of a glass substrate.

FIG. 7b is a plan view of deformation between the upper edge portion and the lower edge portion of the glass substrate.

FIG. 8 is a perspective view of a glass substrate conveyance device according to a fourth embodiment of the present invention.

FIG. 9a is a plan view of deformation between an upper edge portion and a lower edge portion of a glass substrate.

FIG. 9b is a plan view of deformation between the upper edge portion and the lower edge portion of the glass substrate.

FIG. 10 is a perspective view of a glass substrate conveyance device according to a fifth embodiment of the present invention.

FIG. 11a is a plan view of deformation between an upper edge portion and a lower edge portion of a glass substrate.

FIG. 11b is a plan view of deformation between the upper edge portion and the lower edge portion of the glass substrate.

FIG. 12 is a perspective view of a glass substrate conveyance device according to a sixth embodiment of the present invention.

FIG. 13a is a plan view of deformation between an upper edge portion and a lower edge portion of a glass substrate.

FIG. 13b is a plan view of deformation between the upper edge portion and the lower edge portion of the glass substrate.

### DESCRIPTION OF EMBODIMENTS

Now, description is made of embodiments of the present invention with reference to the accompanying drawings. Note that, in the embodiments described below, movable chucks 10 are used as movable gripping means, and fixed chucks 11 are used as gripping means other than the movable gripping means. Further, movable guides 12 and fixed guides 13 are used as guide members. Still further, servo motors 6, cylinders 7, and motors 8 are used as drive means for driving the movable gripping means, and lower-edge-portion gripping chucks 20 are used as another gripping means for gripping a lower edge portion of a substrate. In addition, a first sensor 40 is used as measurement means for measuring a deflection of the lower edge portion of the substrate, and an inspection region A2 is provided as a work area in which the substrate is subjected to processes.

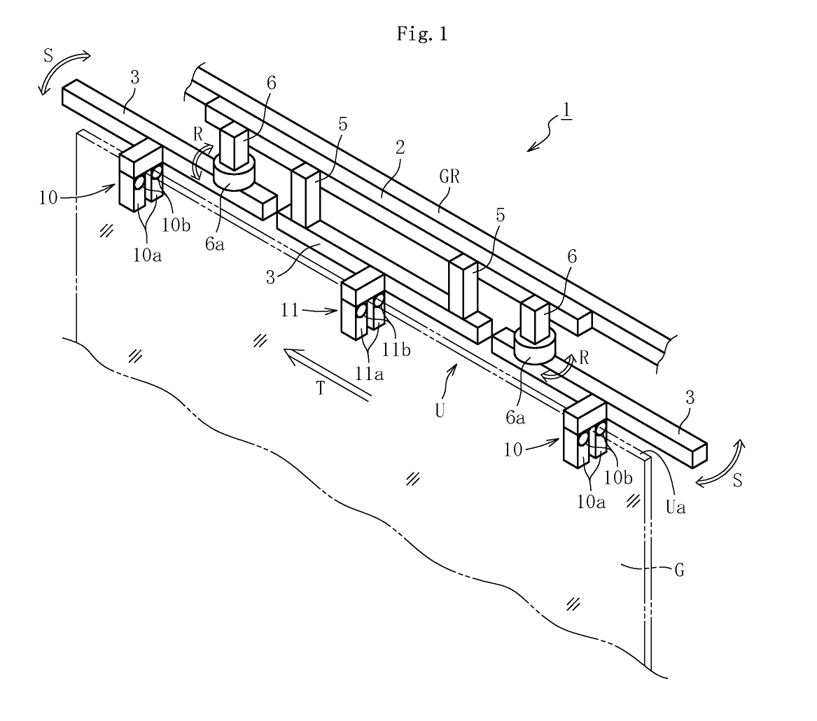

FIG. 1 is a perspective view of a glass substrate conveyance device 1 according to a first embodiment of the present invention. As illustrated in FIG. 1, the glass substrate conveyance device 1 comprises a main frame 2 that moves along a guide rail GR in a conveyance direction T illustrated in FIG. 1, three sub frames 3 suspended from the main frame 2, and the movable chucks 10 and the fixed chuck 11 that are fixed respectively to the sub frames 3 and grip an upper edge portion U of a glass substrate G (hereinafter abbreviated as substrate G).

Of the three sub frames 3, a sub frame 3 located at a center is fixed by two arms 5 while being suspended from the main frame 2. Further, two sub frames 3 located at both ends are suspended from the main frame 2 through intermediation of the servo motors 6 fixed to the main frame 2 and each including a speed reducer. In addition, in conjunction with turning of a rotational drive portion 6a provided to each of the servo motors 6 in a direction R in FIG. 1, the sub frames 3 each fixed to a lower portion of the rotational drive portion 6a pivot in a direction S in an initial state illustrated in FIG. 1.

The sub frame 3 located at the center comprises the fixed chuck 11, and the two sub frames 3 located at both the ends each comprise the movable chuck 10. The movable chucks 10 and the fixed chuck 11 are arranged in alignment with each other as viewed from above and sideways in the initial state. Further, both the chucks 10 and 11 respectively comprise pairs of claw portions 10a and 11a as parts for gripping the upper edge portion U of the substrate G. The pairs of claw portions 10a and 11a are opened and closed by being turned due to air pressure about shafts 10b and 11b fixed to both the chucks 10 and 11. Further, in conjunction with the pivoting of the sub frames 3 in the direction S, the movable chucks 10 each pivot along a circular trajectory in an imaginary plane (not shown) that is parallel to an upper end surface Ua of the substrate G, that is, in a horizontal plane.

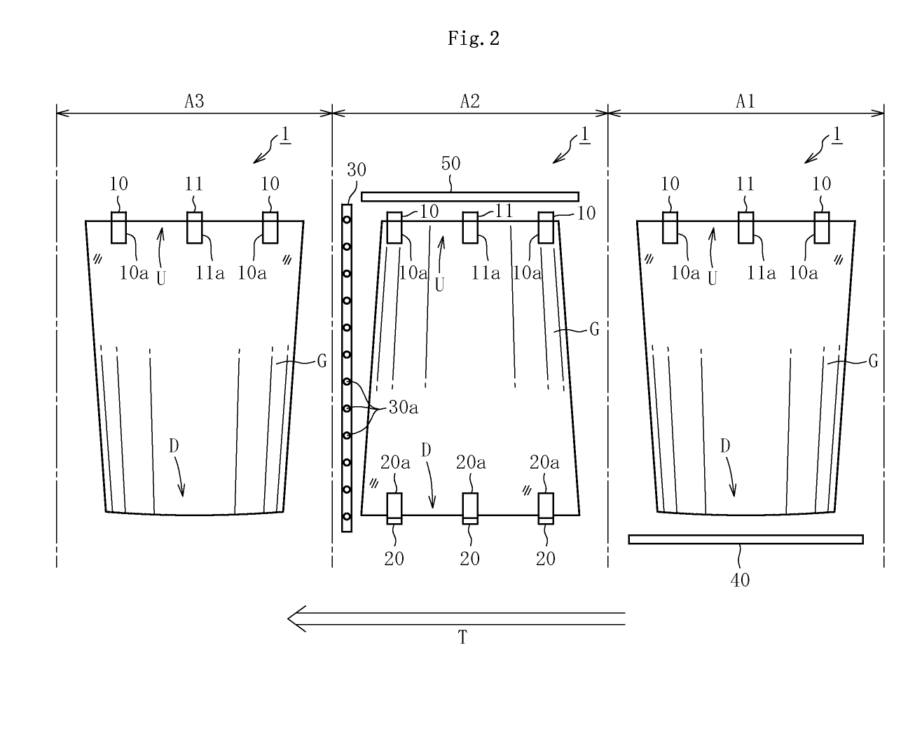

Now, with reference to FIG. 2, description is made of a configuration of a conveyance path on which the glass substrate conveyance device 1 according to the first embodiment described above conveys the substrate G. Note that, in the configuration described below, defect inspection is performed during conveyance of the substrate G, and then the substrate G is transferred to a subsequent step. Note that, in the subsequent step, another conveyance device 1 having the same configuration as described above is used.

FIG. 2 is a side view of the conveyance path for the substrate G. Note that, in FIG. 2, components other than the movable chucks 10 and the fixed chuck 11 in the configuration of the glass substrate conveyance device 1 according to the first embodiment described above are not shown. The conveyance path for the substrate G comprises, along the conveyance direction T illustrated in FIG. 2, a measurement region A1 in which a magnitude of the deflection of a lower edge portion D of the substrate G is measured, the inspection region A2 in which the defect inspection is performed, and a transfer region A3 in which the substrate G is transferred to the subsequent step.

The measurement region A1 comprises the first sensor 40 for measuring the magnitude of the deflection of the lower edge portion D of the substrate G conveyed from an upstream side. Information items of results of measurement by the first sensor 40 are transmitted as electrical signals to control means (not shown) via a circuit (not shown). Then, the servo motors 6 are controlled in response to the signals. In this way, feedback control is performed.

The inspection region A2 comprises the three lower-edge-portion gripping chucks 20 for gripping the lower edge portion D of the substrate G conveyed from the measurement region A1, a second sensor 50 for measuring changes in position and/or posture of the movable chucks 10 from those in an initial state, and a line sensor 30 for performing defect inspection on front and back surfaces of the substrate G.

The lower-edge-portion gripping chucks 20 are arranged in alignment with each other as viewed from above and sideways. In addition, the lower-edge-portion gripping chucks 20 each comprise a gripping portion 20a for gripping the lower edge portion D of the substrate G. The gripping portion 20a is formed of a pair of plate-like members that slide to move along a thickness direction of the substrate G, and is capable of gripping and releasing the substrate G. Further, the information items of the changes in position and/or posture of the movable chucks 10 from those in the initial state, which are obtained by the second sensor 50, can be stored in storage means (not shown), and then transmitted to servo motors 6 of other similar movable chucks 10 that are used in the subsequent step. Note that, the above-mentioned information items of the changes in position and/or posture of the movable chucks 10 from those in the initial state may be stored in the storage means as rotation angles of the servo motors 6 (or movement amounts of the cylinders 7 or a rotation amount of the motor 8, which are described below). Further, the line sensor 30 comprises a plurality of cameras 30a that are arrayed in upper and lower directions and perform defect inspection based on changes in intensity of light that is radiated to the front surface side of the substrate G and received on the back surface side of the substrate G.

In the transfer region A3, the substrate G under a state in which the defect inspection thereon is completed and the lower edge portion D thereof is released is conveyed to a downstream end of the conveyance path, and then transferred to the subsequent step.

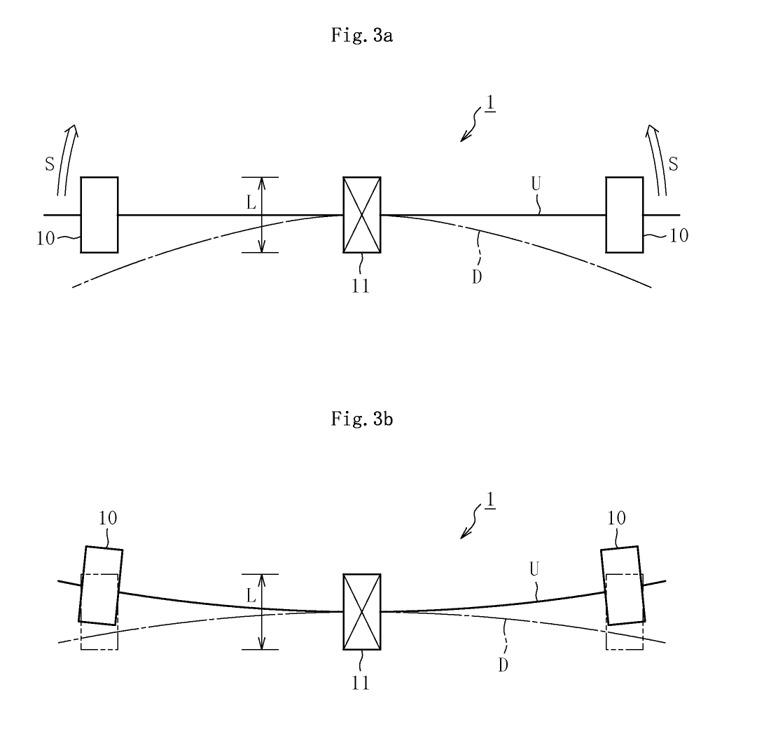

Now, with reference to FIGS. 2 and 3, description is made of a conveyance method for conveying the substrate G along the conveyance path described above by using the glass substrate conveyance device 1 according to the first embodiment described above. Here, it is preferred that the substrate G to be conveyed be flexible, and the substrate G have a thickness of from 0.2 mm to 0.7 mm.

First, in the measurement region A1, the substrate G conveyed from the upstream side is stopped above the first sensor 40 so as to measure the magnitude of the deflection of the lower edge portion D of the substrate G. At this time, when a measured value of the magnitude of the deflection exceeds a movable range L of the lower-edge-portion gripping chucks 20 provided in the inspection region A2, the magnitude of the deflection of the lower edge portion D is corrected as illustrated in FIG. 3.

FIG. 3a is a plan view illustrating a state in which an initial state of the substrate G stopped above the first sensor 40 is viewed from above in a vertical direction. An outline of the upper edge portion U of the substrate G is indicated by the solid line, and an outline of the lower edge portion D is indicated by the dashed line. Note that, also in those drawings, the components other than the movable chucks 10 and the fixed chuck 11 in the configuration of the glass substrate conveyance device 1 are not shown.

When the measured value of the magnitude of the deflection of the lower edge portion D exceeds the movable range L of the lower-edge-portion gripping chucks 20, an information item of the measured value is transmitted as an electrical signal to the control means (not shown) via the circuit. Then, the servo motors 6 are controlled in response to the signal. In this way, the feedback control is performed. With this, the rotational drive portion 6a provided to each of the servo motors 6 turns to pivot the movable chucks 10 fixed to the sub frames 3 in the direction S. As a result, the upper edge portion U is deformed, and in accordance therewith, the magnitude of the deflection of the lower edge portion D is corrected to fall within the movable range L of the lower-edge-portion gripping chucks 20 as illustrated in FIG. 3b. Then, the substrate G that has been corrected in magnitude of the deflection of the lower edge portion D is conveyed to the inspection region A2.

For the defect inspection, the lower edge portion D of the substrate G that has been conveyed to the inspection region A2 is gripped by the gripping portions 20a provided to the lower-edge-portion gripping chucks 20, and is tensioned. At this time, the magnitude of the deflection of the lower edge portion D has been corrected in the measurement region A1, and hence the lower edge portion D can be smoothly gripped. Thus, the problem of a decrease in yield of products due to failure in gripping can be solved.

Further, at the time when the lower edge portion D of the substrate G is gripped by the lower-edge-portion gripping chucks 20, the changes in position and posture of the movable chucks 10 from those in the initial state are measured by the second sensor 50, and information items of measurement values thereof are transmitted to the subsequent step. In this way, the information items of the changes in position and posture of the movable chucks 10 are transferred to the subsequent step even in a case where the lower edge portion D of the substrate G needs to be gripped again so as to perform additional inspection or processes in the subsequent step by using another glass substrate conveyance device 1 having the same configuration. Thus, in the subsequent step, the lower edge portion D of the substrate G can be smoothly gripped.

After the lower edge portion D is gripped by the lower-edge-portion gripping chucks 20 as described above, the rotational drive portions 6a provided to the servo motors 6 are each turned reversely in the direction R. In conjunction therewith, the sub frames 3 pivot to initial positions along the direction S, and hence the movable chucks 10 provided to the sub frames 3 each return into the initial state as well. As a result, the outline of the upper edge portion U of the substrate G is restored to a linear shape. After that, the substrate G under a state in which the upper edge portion U and the lower edge portion D thereof are gripped is conveyed to the downstream side so as to pass by the line sensor 30. With this, the defect inspection can be performed by the cameras 30a provided to the line sensor 30.

The substrate G that has been subjected to the defect inspection is released from the lower-edge-portion gripping chucks 20. Under a state in which only the upper edge portion U thereof is gripped, the substrate G is conveyed to the subsequent step through the transfer region A3. Then, when reaching a downstream end of the transfer region A3, the substrate G is transferred to the subsequent step.

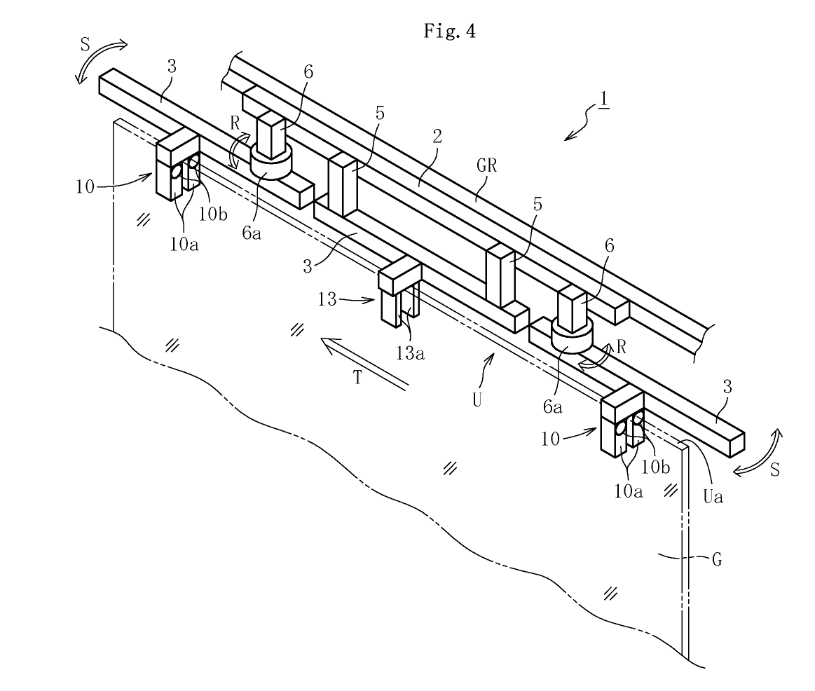

FIG. 4 is a perspective view of a glass substrate conveyance device 1 according to a second embodiment of the present invention. Note that, in FIG. 4, components having the same functions or shapes as those of the glass substrate conveyance device 1 according to the first embodiment described above are denoted by the same reference symbols, and redundant description thereof is omitted. In addition, also in third to sixth embodiments described below, redundant description of components having the same functions or shapes as those of glass substrate conveyance devices according to preceding embodiments is omitted as well. Further, in this embodiment and the third to sixth embodiments described below, the conveyance path for conveying the substrate G has the same configuration as that in the first embodiment described above.

The glass substrate conveyance device 1 according to the second embodiment is different from the glass substrate conveyance device 1 according to the first embodiment in that the sub frame 3 located at the center comprises the fixed guide 13 instead of the fixed chuck 11. The fixed guide 13 comprises a guide portion 13a for guiding the upper edge portion U of the substrate G, and the guide portion 13a is formed of a pair of plate-like members that are slidable in the thickness direction of the substrate G due to the air pressure. Further, play is secured between the guide portion 13a and the substrate G so as not to completely fasten the substrate G.

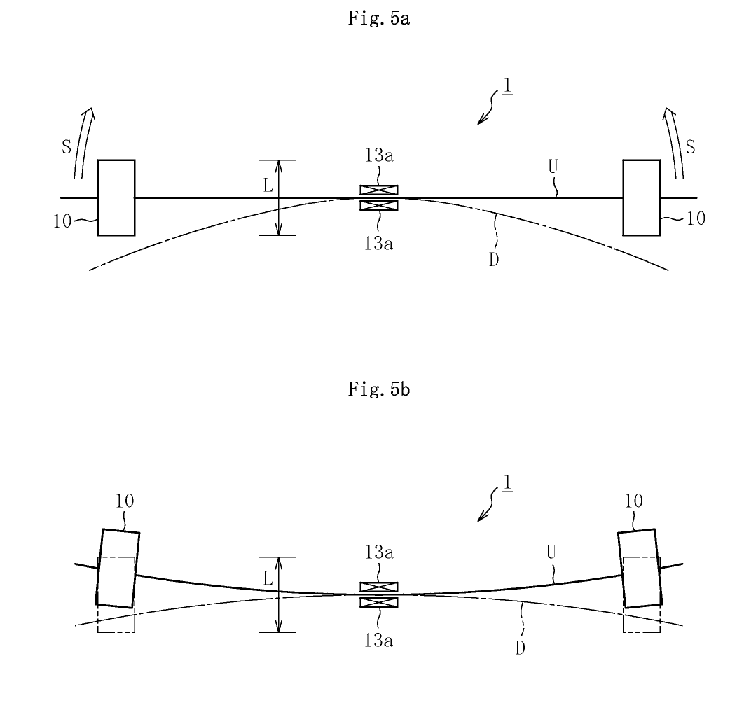

According to a glass substrate conveyance method using the conveyance device 1, as illustrated in FIGS. 5a and 5b, a preferred embodiment can be carried out when correcting the shape of the lower edge portion D so that the magnitude of the deflection of the lower edge portion D falls within the movable range L of the lower-edge-portion gripping chucks 20. Specifically, a part that is guided by the guide portion 13a is not completely fastened, and hence a risk of generation of local stress to the substrate G can be reduced at the time when the movable chucks 10 are operated to deform the upper edge portion U of the substrate G. Further, other risks such as occurrence of cracking of the substrate G or breakage of the substrate G due to vibration of the glass substrate conveyance device 1 and variation in accuracy at the time of setting to the lower-edge-portion gripping chucks 20 can be appropriately prevented. Note that, in FIGS. 5a and 5b, as in the first embodiment described above, the outline of the upper edge portion U of the conveyed substrate G is indicated by the solid line, and the outline of the lower edge portion D is indicated by the dashed line. Further, also in FIGS. 5a and 5b, components other than the movable chucks 10 and the guide portion 13a provided to the fixed guide 13 in the configuration of the glass substrate conveyance device 1 are not shown. Such illustration is applied also to the third to sixth embodiments described below.

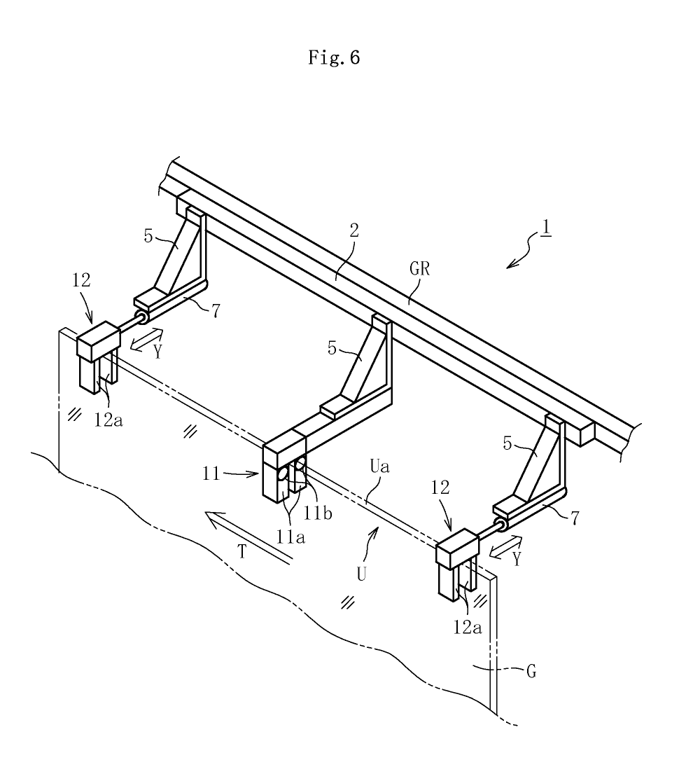

FIG. 6 is a perspective view of a glass substrate conveyance device 1 according to the third embodiment of the present invention. As illustrated in FIG. 6, the glass substrate conveyance device 1 comprises the main frame 2 that moves along the guide rail GR in the conveyance direction T illustrated in FIG. 6, the three arms 5 fixed to the main frame 2, the fixed chuck 11 for gripping the upper edge portion U of the substrate G, and movable guides 12 for guiding the upper edge portion U of the substrate G.

Of the three arms 5, two arms 5 located at both the ends each comprise the cylinder 7 that is fixed to a lower portion thereof. In conjunction with an operation of a piston incorporated in the cylinder 7, the movable guides 12 can be moved in the horizontal plane along a direction Y (straight line trajectory) illustrated in FIG. 6. Further, the movable guides 12 each comprise a guide portion 12a for guiding the upper edge portion U of the substrate G, and the guide portion 12a is formed of a pair of plate-like members that are slidable in the thickness direction of the substrate G due to the air pressure. Still further, play is secured between the guide portion 12a and the substrate G so as not to completely fasten the substrate G. In addition, the fixed chuck 11 is fixed to a distal end of an arm 5 located at the center.

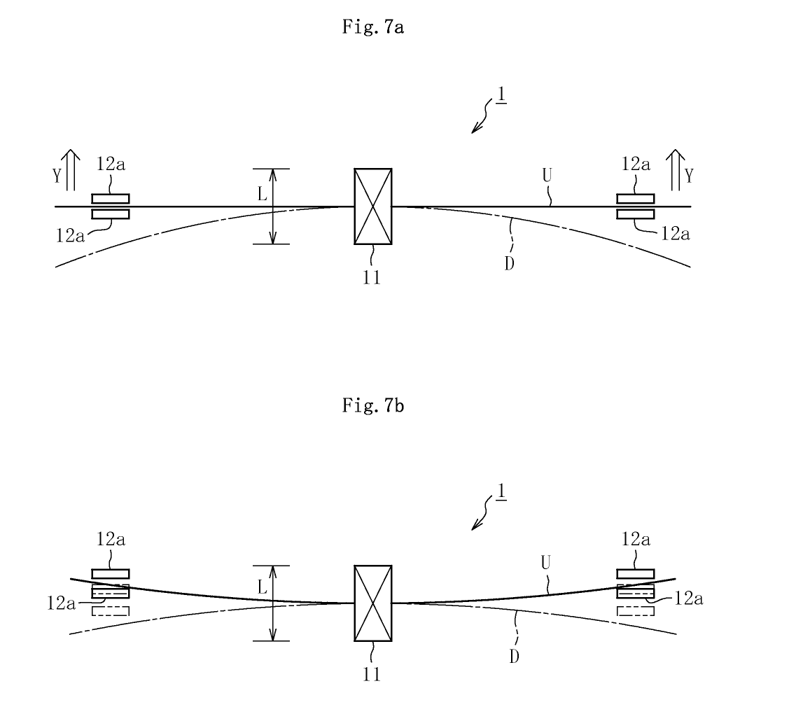

Also by the glass substrate conveyance method using this conveyance device 1, as illustrated in FIGS. 7a and 7b, when the movable guides 12 are moved in the direction Y, the shape of the lower edge portion D can be corrected so that the magnitude of the deflection of the lower edge portion D falls within the movable range L of the lower-edge-portion gripping chucks 20. Further, this glass substrate conveyance device 1 has an advantage in its simple structure.

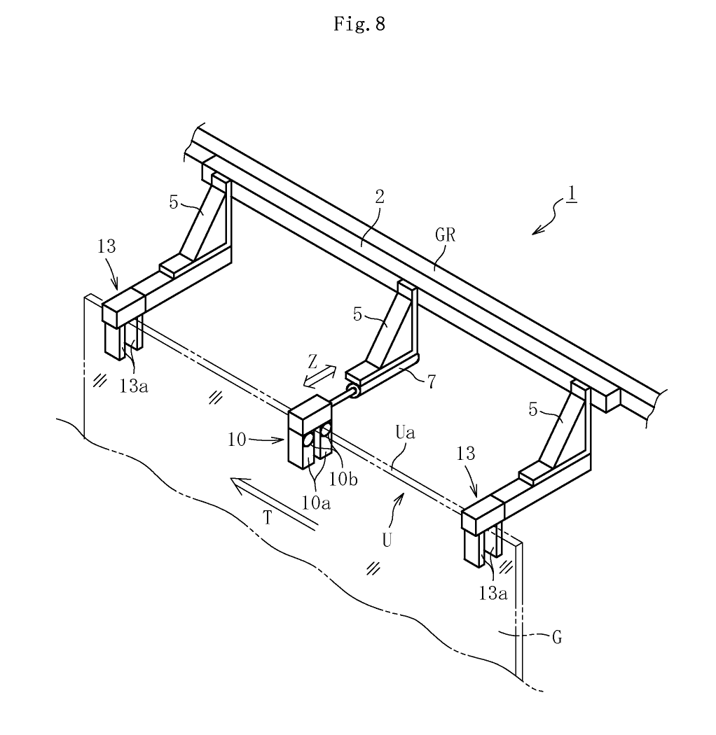

FIG. 8 is a perspective view of a glass substrate conveyance device 1 according to the fourth embodiment of the present invention. The glass substrate conveyance device 1 according to the fourth embodiment has a different configuration from that of the glass substrate conveyance device 1 according to the third embodiment described above in the following matters. The fixed guide 13 is fixed to a distal end of each of the arms located at both the ends. The cylinder 7 is fixed to a lower portion of the arm 5 located at the center, and in conjunction with the operation of the piston in the cylinder 7, the movable chuck 10 can be moved in the horizontal plane along a direction Z (straight line trajectory) illustrated in FIG. 8.

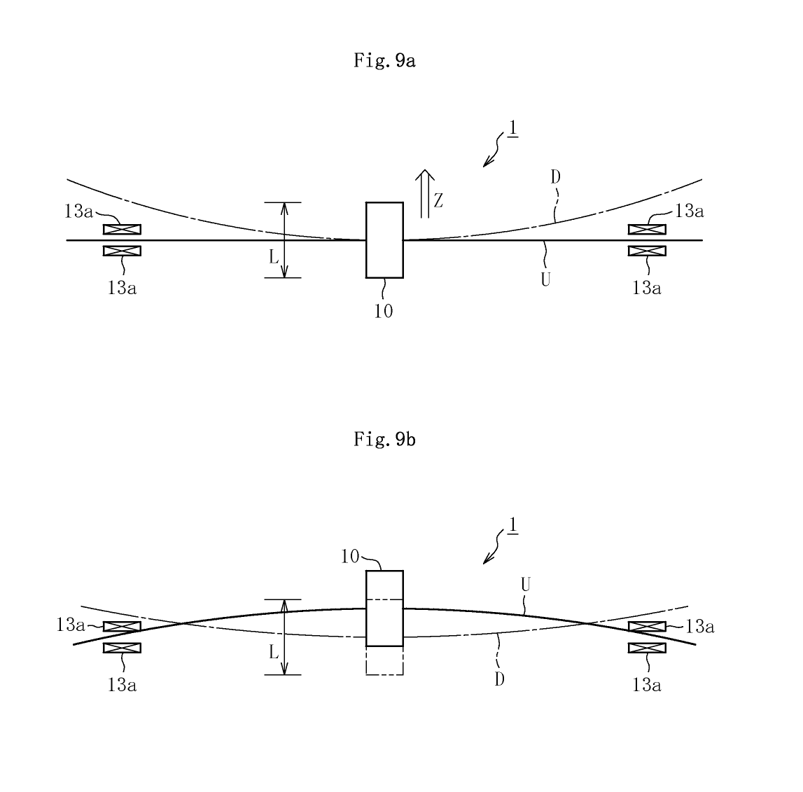

Also by a glass substrate conveyance method using this conveyance device 1, as illustrated in FIGS. 9a and 9b, when the movable chuck 10 is moved in the direction Z, the shape of the lower edge portion D can be corrected so that the magnitude of the deflection of the lower edge portion D falls within the movable range L of the lower-edge-portion gripping chucks 20. Further, as in the glass substrate conveyance device 1 according to the third embodiment described above, this glass substrate conveyance device 1 has the advantage in its simple structure.

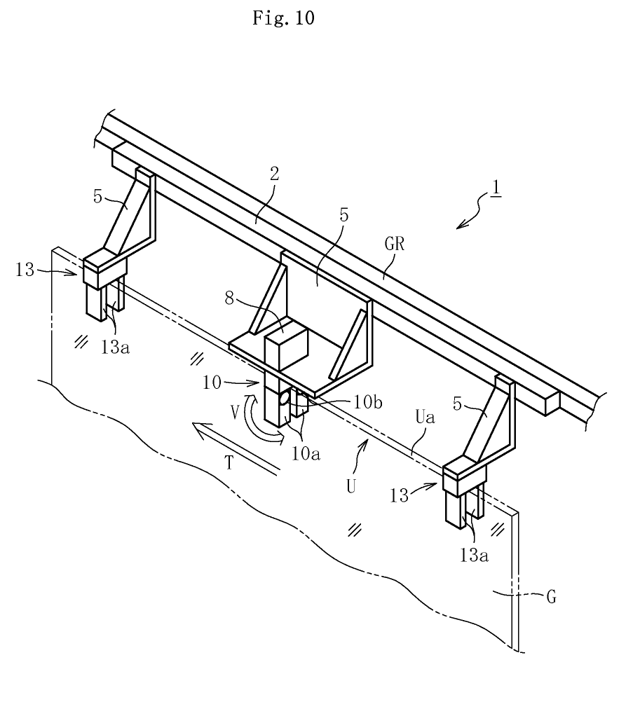

FIG. 10 is a perspective view of a glass substrate conveyance device 1 according to the fifth embodiment of the present invention. As illustrated in FIG. 10, the glass substrate conveyance device 1 comprises the main frame 2 that moves along the guide rail GR in the conveyance direction T illustrated in FIG. 10, the three arms 5 fixed to the main frame 2, the movable chuck 10 for gripping the upper edge portion U of the substrate G, and the fixed guides 13 for guiding the upper edge portion U of the substrate G.

The motor 8 is fixed to the arm. 5 located at the center. The motor 8 comprises a rotary shaft penetrating the arm 5 and connected to the movable chuck 10 that is provided under the arm 5. With this, in conjunction with rotation of the motor 8, the movable chuck 10 can be turned about the movable chuck 10 itself as a rotation axis in a direction V illustrated in FIG. 10. Further, the fixed guide 13 is fixed to each of the lower portions of the arms 5 located at both the ends.

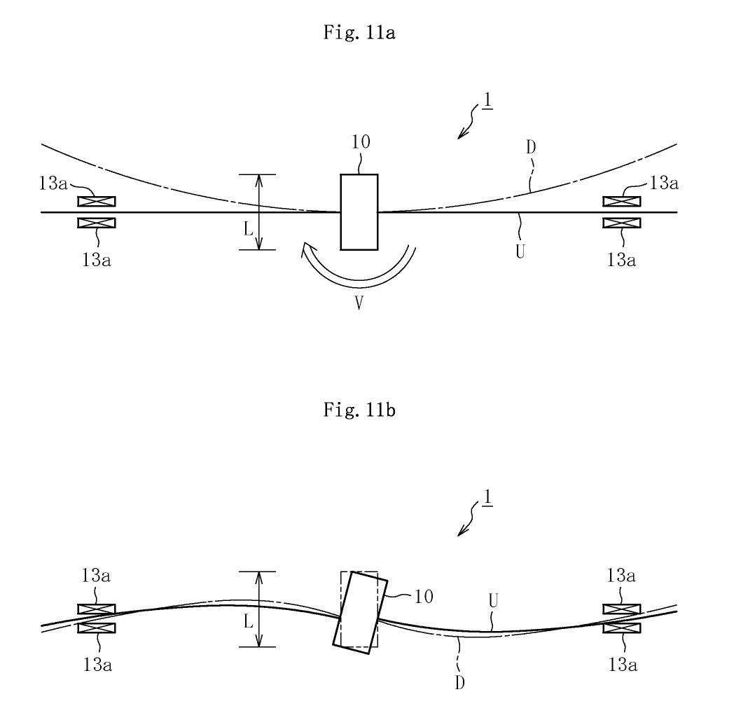

Also by a glass substrate conveyance method using this conveyance device 1, as illustrated in FIGS. 11a and 11b, when the movable chuck 10 is turned on its axis in the direction V, the shape of the lower edge portion D can be corrected so that the magnitude of the deflection of the lower edge portion D falls within the movable range L of the lower-edge-portion gripping chucks 20. Further, the upper edge portion U of the substrate G can be curved into an S-shape, and hence there is an advantage of high bending resistance. In this case, the curve of the substrate G into the S-shape may cause a risk of generation of high local stress to the substrate G. However, both ends in a longitudinal direction of the upper edge portion U of the substrate G are not fastened but only guided by the guide portions 13a provided to the fixed guides 13. Thus, such risks are appropriately eliminated.

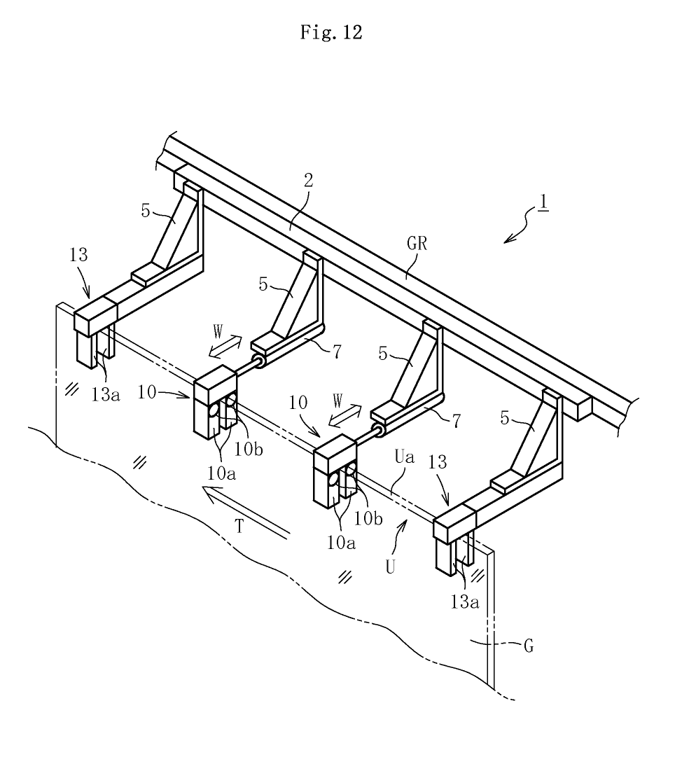

FIG. 12 is a perspective view of a glass substrate conveyance device 1 according to the sixth embodiment of the present invention. The glass substrate conveyance device 1 according to the sixth embodiment has a different configuration from that of the glass substrate conveyance device 1 according to the fourth embodiment described above in the following matters. Unlike the fourth embodiment described above in which the only one movable chuck 10 is provided between the two fixed guides 13 for guiding the upper edge portion U of the substrate G, two movable chucks 10 are provided therebetween in this embodiment. In conjunction with the operation of the piston incorporated in each of the cylinders 7, the movable chucks 10 can be moved in the horizontal plane along a direction W (straight line trajectory) illustrated in FIG. 12. Further, both the movable chucks 10 are movable to opposite sides in the direction W.

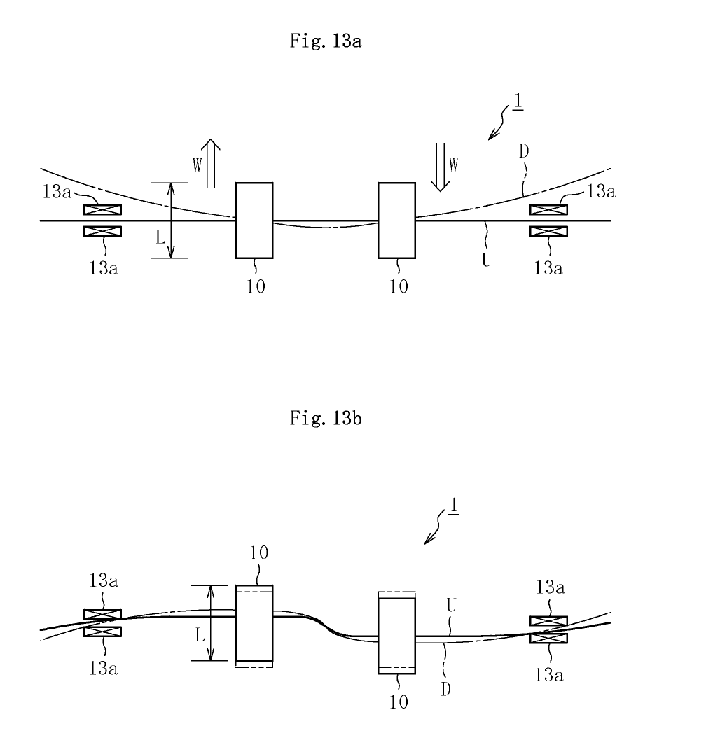

Also by a glass substrate conveyance method using this glass substrate conveyance device 1, as illustrated in FIGS. 13a and 13b, when both the movable chucks 10 are moved in the direction W, the shape of the lower edge portion D can be corrected so that the magnitude of the deflection of the lower edge portion D falls within the movable range L of the lower-edge-portion gripping chucks 20. Further, as in the fifth embodiment described above, the upper edge portion U of the substrate G can be curved into an S-shape, and hence there is an advantage of high bending resistance. In addition, the structure of the device can be simplified.

Here, the configuration of the glass substrate conveyance device according to the present invention is not limited to those of the glass substrate conveyance devices 1 according to the first to sixth embodiments described above. In the configurations of the embodiments described above, the movable chucks 10 or the movable guides 12 each pivot along the circular trajectory or move along the straight line trajectory in the horizontal plane. However, those chucks and guides may each be operated along a trajectory obtained by combining those trajectories. Alternatively, the operation along those trajectories and the operation of on-axis turning disclosed in the fifth embodiment may be used in combination. Still alternatively, the movable guides 12 or the fixed guides 13 of the glass substrate conveyance devices according to the respective embodiments may be moved parallel to the conveyance direction of the substrate G. With this configuration, the risk of generation of high local stress to the substrate G can be further reduced. In addition, the numbers and the arrangement positions of the movable chucks 10, the fixed chucks 11, the movable guides 12, and the fixed guides 13 are not limited to those in the configurations disclosed in the respective embodiments, and may be appropriately changed in consideration of a size and a weight of the substrate G to be conveyed.

Further, the configuration of the conveyance path for the substrate G is not limited to those in the configurations disclosed in the embodiments described above. In the embodiments described above, the measurement region A1 comprises the first sensor 40 for measuring the magnitude of the deflection of the lower edge portion D of the substrate G, and the inspection region A2 comprises the second sensor 50 for measuring the changes in position and posture of the movable chucks 10 from those in the initial state. However, both the sensors may be arranged in the same region so that the measurements are performed simultaneously with each other. In addition, in the cases disclosed in the embodiments described above, the defect inspection is performed during the conveyance of the substrate G, but the glass substrate conveyance device according to the present invention can be used in other cases such as a case of performing a cutting process on the substrate G during the conveyance of the substrate G.

Further, in the embodiments described above, after the defect inspection on the substrate G, the substrate G is conveyed with the upper edge portion U of the substrate G being maintained in a straight shape. For example, the substrate G may be conveyed with the upper edge portion U being deformed into the S-shape. With this, the substrate G is less liable to rock even when disturbed airflow in the apparatus, vibration of the apparatus, and the like are applied to the substrate G. Thus, a risk of contact of the substrate G with, for example, members provided around the conveyance path can be reliably avoided. Further, in such a case, when the glass substrate conveyance device according to the present invention is employed as a conveyance device for the substrate G in the subsequent step, the substrate G may be transferred to the subsequent step with the shape of the upper edge portion U being maintained into the S-shape at the downstream end of the conveyance path (downstream end of the transfer region A3). With this, the changes in position and/or posture of the movable gripping means from those in the initial state, which are measured in the inspection region A2, are transmitted to the subsequent step. Thus, even when the upper edge portion U is not restored into the straight shape, the upper edge portion U of the substrate G can be smoothly gripped by the movable chucks 10 and the fixed chucks 11 in the subsequent step.

### REFERENCE SIGNS LIST

1 glass substrate conveyance device
6 servo motor
7 cylinder
8 motor
10 movable chuck
11 fixed chuck
12 movable guide
13 fixed guide
T conveyance direction
G glass substrate
U upper edge portion of glass substrate
D lower edge portion of glass substrate
Ua upper end surface of glass substrate
20 lower-edge-portion gripping chuck
40 first sensor
50 second sensor

1. A glass substrate conveyance device, comprising a plurality of gripping means for gripping an upper edge portion of a glass substrate in a vertical posture so as to support the glass substrate in a suspended manner,
the glass substrate conveyance device being configured to convey, in a conveyance direction along the upper edge portion, the glass substrate that is supported in the suspended manner by the plurality of gripping means,
wherein the plurality of gripping means comprise at least one movable gripping means that is changeable in position and/or posture in a horizontal plane.

2. The glass substrate conveyance device according to claim 1, wherein the at least one movable gripping means is configured to pivot along a circular trajectory in the horizontal plane.

3. The glass substrate conveyance device according to claim 1, wherein the at least one movable gripping means is configured to turn on its axis about a vertical line.

4. The glass substrate conveyance device according to claim 1, wherein the at least one movable gripping means is configured to move in a direction that is perpendicular to the conveyance direction.

5. The glass substrate conveyance device according to claim 1, wherein the at least one movable gripping means is configured to move in a direction that is parallel to the conveyance direction.

6. The glass substrate conveyance device according to claim 1, wherein, during a period in which the glass substrate that is supported in the suspended manner by the plurality of gripping means is subjected to a predetermined process in a work area, the at least one movable gripping means is maintained in an initial state in which the at least one movable gripping means is unchanged in position and/or posture, and a lower edge portion of the glass substrate is gripped by a plurality of other gripping means.

7. The glass substrate conveyance device according to claim 1,
wherein the plurality of gripping means comprising the at least one movable gripping means are provided in a plurality of areas corresponding to a plurality of steps, and
wherein, when the glass substrate that is supported in the suspended manner by the plurality of gripping means in a preceding step is transferred to the plurality of gripping means in a subsequent step, the at least one movable gripping means is maintained in the initial state in which the at least one movable gripping means is unchanged in position and/or posture.

8. The glass substrate conveyance device according to claim 1, further comprising:
drive means for driving the at least one movable gripping means;
measurement means for measuring a deflection of the lower edge portion of the glass substrate; and
control means for controlling the drive means in response to a signal from the measurement means.

9. The glass substrate conveyance device according to claim 1,
wherein the plurality of gripping means comprising the at least one movable gripping means are provided in the plurality of areas corresponding to the plurality of steps, and
wherein, when the glass substrate that is supported in the suspended manner by the plurality of gripping means in the preceding step is transferred to the plurality of gripping means in the subsequent step, operation information of the drive means for driving the at least one movable gripping means in the preceding step is stored in advance, and the drive means for driving the at least one movable gripping means in the subsequent step is controlled based on the operation information that is stored in advance.

10. The glass substrate conveyance device according to claim 1, wherein a part of the plurality of gripping means is replaced with a guide member for loosely holding and guiding the upper edge portion of the glass substrate.

11. A glass substrate conveyance method, comprising a plurality of gripping means for gripping an upper edge portion of a glass substrate in a vertical posture so as to support the glass substrate in a suspended manner,
the glass substrate conveyance method comprising conveying, in a conveyance direction along the upper edge portion, the glass substrate that is supported in the suspended manner by the plurality of gripping means,
the plurality of gripping means comprising at least one movable gripping means that is changeable in position and/or posture in a horizontal plane,
the conveying comprising conveying the glass substrate that is supported in the suspended manner by the at least one movable gripping means.
